(19) United States
(12) Patent Application Publication
(10) Pub. No.: US 2018/0262978 A1
(43) Pub. Date: Sep. 13, 2018

(54) SHARING PRIVATE NETWORK SMALL CELLS WITH PUBLIC NETWORKS

(71) Applicants: Colin Leon Kahn, Morris Plains, NJ (US); Rajiv Narahari, Bengaluru (IN); Rajat Shah, Bengaluru (IN)

(72) Inventors: Colin Leon Kahn, Morris Plains, NJ (US); Rajiv Narahari, Bengaluru (IN); Rajat Shah, Bengaluru (IN)

(21) Appl. No.: 15/454,965

(22) Filed: Mar. 9, 2017

(51) Int. Cl. H04W 48/18; H04H 20/16; H04W 72/12; H04W 72/10

(52) U.S. Cl. CPC H04W 48/18; H04H 20/16; H04W 88/06; H04W 72/10; H04W 72/121

(57) ABSTRACT

A small cell includes a transceiver configured to receive and access request from a wireless-enabled device. The small cell also includes a processor configured to selectively provide the wireless-enabled device with private access to an enterprise network and public access to one or more core networks of mobile network operators based on an identifier included in the access request. The wireless-enabled device includes a transceiver configured to receive, from the small cell, broadcast information including an identifier of the enterprise network or the one or more core networks. The wireless-enabled device also includes a processor configured to compare the broadcast information to configuration information stored in the wireless-enabled device. The configuration information includes identifiers of the enterprise network or the core networks. The processor is configured to selectively provide the access request to the small cell based on the comparison.

### BACKGROUND

Wireless connectivity is typically provided by mobile network operators that own (or control) a portion of the licensed spectrum. User equipment can subscribe to services provided by a mobile network operator. The user equipment can then access a wireless communication system by establishing a connection over an air interface to a base station in the portion of the licensed spectrum owned (or controlled) by the mobile network operator. Path loss between external base stations and locations within buildings, particularly large buildings, can degrade signal strength within the building and make it difficult or impossible for user equipment to establish a connection with the external base station. Providing cellular coverage and capacity inside of buildings therefore often requires deploying additional hardware such as repeaters, distributed antenna systems, or small cells within the building. Mobile network operators generally compete with each other and, consequently, each mobile network operator typically deploys their own network infrastructure, including communication hardware and an associated core network, to provide coverage within each building that is served by the mobile network operator. Deploying separate network infrastructure to provide in-building coverage for each mobile network operator multiplies the cost of providing in-building coverage.

Furthermore, organizations, corporations, or other groups (referred to herein as “enterprises”) often support an enterprise network that is only available to users that have been authorized by the enterprise, such as members or employees. Users that have a subscription with a mobile network operator that provides wireless connectivity in a building owned by the enterprise cannot directly access the enterprise network via small cells (or other network infrastructure) deployed in the building. Instead, authorized users establish a connection with a core network supported by the mobile network operator via the small cells (or other network infrastructure) that the mobile network operator maintains within the building. The authorized users can then access the enterprise network using an over-the-top mechanism such as establishing a secure tunnel between the core network and the enterprise network. Authorized users that do not have a subscription with a mobile network operator that serves the building may not be able to access the enterprise network from within the building. Unauthorized users that only have a subscription with another mobile network operator that does not serve the building may be unable to access the wireless communication system from within the building. Thus, mobile network operators end up vying to provide service to the enterprise that is incompatible with existing infrastructure deployed by other mobile network operators, while third parties deploy wired and Wi-Fi-based infrastructure that does not support mobility in the buildings owned by the enterprise.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a wireless communication system according to some embodiments.

FIG. 2 is a block diagram of a wireless communication system that includes an enterprise network that is owned or operated by an enterprise according to some embodiments.

FIG. 3 is a block diagram of a wireless communication system that includes a third-party datacenter that is supports an enterprise network for an enterprise according to some embodiments.

FIG. 4 illustrates a set of wireless-enabled devices that are configured to access enterprise networks and public networks according to some embodiments.

FIG. 5 illustrates a wireless communication system including a small cell that is configured to selectively provide access to wireless-enabled devices in closed subscriber groups (CSGs) according to some embodiments.

FIG. 6 is a flow diagram of a method implemented in a wireless-enabled device for establishing a connection to an enterprise network or an MNO via a small cell according to some embodiments.

FIG. 7 is a flow diagram of a method for selectively providing access to an enterprise network or an MNO network via a small cell according to some embodiments.

FIG. 8 is a block diagram of a wireless communication system that includes a small cell to provide shared access to an enterprise network and one or more MNO networks according to some embodiments.

### DETAILED DESCRIPTION

The cost of supplying wireless connectivity within buildings is reduced, and access to core and enterprise networks is improved, by configuring small cells that serve the building to provide enterprise wireless-enabled devices with private access to an enterprise network and to provide non-enterprise wireless-enabled devices with public access to at least one core network of at least one mobile network operator (MNO). Wireless-enabled devices can include user equipment such as cell phones, smart phones, tablet computers, laptop computers, and desktop computers, as well as Internet of Things (IOT) devices such as sensors deployed in appliances, vehicles, or buildings. In operation, the small cells transmit signals advertising availability of access to the at least one core network and/or the enterprise network. In this manner, the small cell can be shared among the MNOs and third parties that provide wireless access. For example, the small cells can be configured to broadcast public land mobile network (PLMN) identifiers of MNOs or network identifiers (which may be PLMN identifiers) of the third parties that provide wireless access.

Wireless-enabled devices are provisioned with an identifier such as a PLMN identifier that identifies an MNO that provides service to the wireless-enabled device. The enterprise wireless-enabled devices are also provisioned with an identifier such as an access point name (APN) that identifies the enterprise network. The enterprise network identifier is transmitted to the small cell to establish a connection to the enterprise network. Some embodiments of the small cells are configured as closed subscriber group (CSG) cells that selectively provide services or priority access to the enterprise wireless-enabled devices. The CSG cells can be “closed” cells that only provide access to enterprise wireless-enabled devices or “hybrid” cells that provide preferential access to the enterprise wireless-enabled devices while also providing public access to non-enterprise wireless-enabled devices. The wireless-enabled devices can be configured with identifiers of CSGs to indicate that they are members of the corresponding CSG.

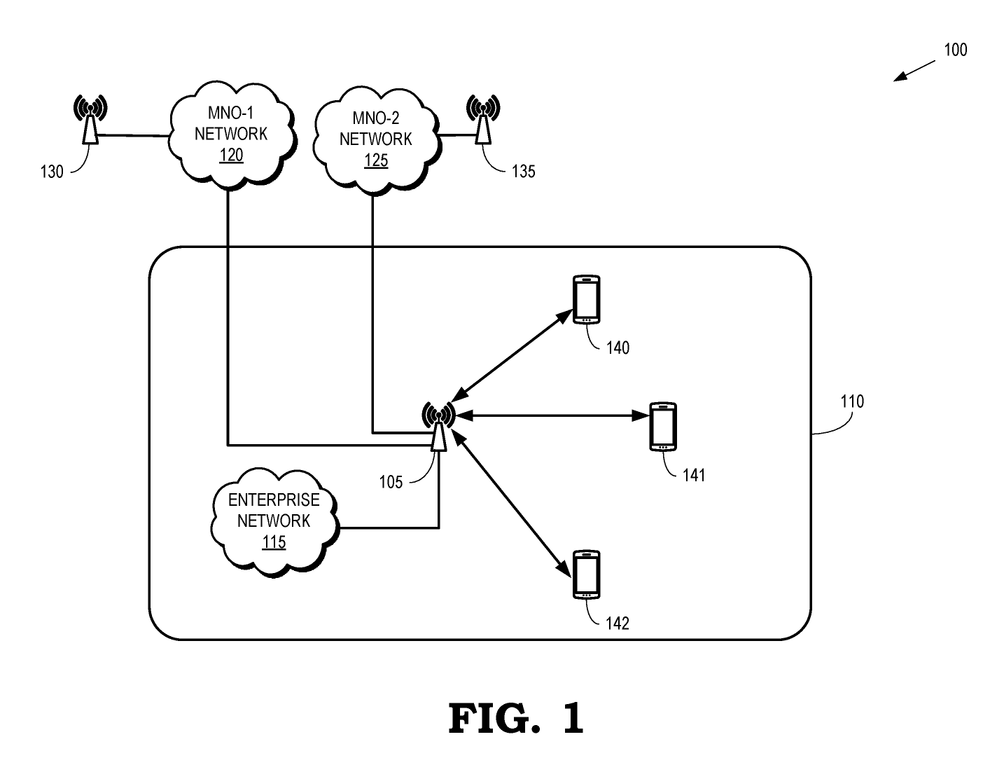

FIG. 1 is a block diagram of a wireless communication system 100 according to some embodiments. The wireless communication system 100 includes one or more small cells 105 that provide wireless connectivity within a perimeter 110 of an enterprise. A single small cell 105 is shown in FIG. 1 in the interest of clarity. However, some embodiments of the wireless communication system 100 implement multiple small cells to provide wireless connectivity within the perimeter 110. The small cells 105 can be implemented as base stations, access points, metrocells, picocells, femtocells, radio heads or other entities that can provide wireless connectivity. The perimeter 110 determines the boundaries of the enterprise. For example, the perimeter 110 can be defined by the geographic boundaries of a campus maintained by the enterprise, the walls of a building that houses the enterprise, a floor of a building that is utilized by the enterprise, one or more rooms of the building utilized by the enterprise, and the like. The perimeter 110 is shown as a single bounded region in the interest of clarity. However, some embodiments of the perimeter 110 encompass multiple disconnected regions such as multiple geographically separated buildings.

The small cell 105 provides shared access to a private network that is associated with the enterprise (referred to herein as the enterprise network 115) and a plurality of public networks that are owned or operated by a corresponding plurality of mobile network operators, MNO-1 network 120 and MNO-2 network 125. As used herein, the term “private network” refers to a network that restricts access to a particular group of authorized wireless-enabled devices. For example, a private network implemented by an enterprise can restrict access to the wireless-enabled devices that are owned by the enterprise or registered with the enterprise, which then verifies authorization of the wireless-enabled devices for access. Membership in the group of wireless-enabled devices that are allowed private access to the private network can be indicated by configuring the wireless-enabled devices with an appropriate identifier, as well as using other authentication techniques such as a username/password combination. As used herein, the term “public network” refers to a network that does not restrict access to a particular group of wireless-enabled devices. For example, any wireless-enabled device that has subscribed to receive services from MNO-1 can access the MNO-1 network 120 and any wireless-enabled device that has subscribed to receive services from MNO-2 can access the MNO-2 network 125. Access to a public network is referred to as “public access.”

The enterprise network 115 is shown within the perimeter 110 to indicate that the enterprise network 115 is associated with the enterprise and access to the enterprise network 115 is restricted to wireless-enabled devices that are authorized by the enterprise. For example, wireless-enabled devices that are owned by (or issued to) employees can be configured as authorized wireless-enabled devices for accessing the enterprise network 115, as discussed herein. However, in some embodiments, some or all of the enterprise network 115 is implemented external to the perimeter 110. Furthermore, the enterprise network 115 can be owned and operated by the enterprise or the enterprise network 115 can be provided to the enterprise by a third-party, which is responsible for operating and maintaining the enterprise network 115 on behalf of the enterprise.

The MNO-1 network 120 provides wireless connectivity using one or more macrocells 130 (only one shown in the interest of clarity), which can be referred to as base stations, eNodeBs, base station routers, and the like. The MNO-2 network 125 provides wireless connectivity using one or more macrocells 135. Coverage areas of the macrocells 130, 135 can overlap with each other and, in some cases, can overlap with coverage areas of the small cell 105. However, the macrocells 130, 135 are not necessarily able to provide wireless connectivity within the perimeter 110, e.g., due to path loss caused by distance, environmental conditions, obstructions such as walls and windows, and the like. The small cell 105 is therefore configured to support shared connectivity with the MNO-1 network 120, the MNO-2 network 125, and the enterprise network 115 so that wireless-enabled devices with subscriptions to MNO-1 and MNO-2 are able to gain public access to the corresponding networks 120, 125 via the small cell 105 and wireless-enabled devices that are authorized by the enterprise can gain private access to the enterprise network 115 via the small cell 105. For example, the enterprise network 115 can verify authorization of the wireless-enabled devices.

Some embodiments of the small cell 105 broadcast information identifying the enterprise network 115, the MNO-1 network 120, and the MNO-2 network 125 to advertise availability of access to these networks via the small cell 105. For example, the small cell 105 can broadcast a public land mobile network (PLMN) identifier of a third-party that provides the private access to the enterprise network 115 and the PLMN identifiers of MNO-1 and MNO-2. The small cell 105 receives access requests from wireless-enabled devices and selectively provides the wireless-enabled device with private access to the enterprise network 115 or public access to the MNO-1 network 120 or the MNO-2 network 125 based on an identifier included in the access request. For example, if an authorized wireless enabled device sends an access request that includes an access point name (APN) that identifies the enterprise network 115, the small cell 105 provides private access to the enterprise network 115 so that the wireless-enabled device can establish a connection to the enterprise network 115 via the small cell. For another example, if the access request includes a PLMN for MON-1, the small cell 105 can provide public access to the MNO-1 network 120 via the small cell 105 so that the wireless-enabled device can establish a connection to the MNO-1 network 120 via the small cell 105.

The wireless communication system 100 illustrates three wireless-enabled devices 140, 141, 142, which are collectively referred to herein as “the wireless-enabled devices 140-142.” The wireless-enabled devices 140-142 are configured to receive broadcast information identifying the enterprise network 115, the MNO-1 network 120, and the MNO-2 network 125. The wireless-enabled devices 140-142 are also configured to compare the broadcast information to configuration information stored in the wireless-enabled devices 140-142. Some embodiments of the configuration information include identifiers of one or more of the enterprise network 115, the MNO-1 network 120, and the MNO-2 network 125. The wireless-enabled devices 140-142 are then configured to transmit an access request to the small cell 105 including an identifier one or more of the enterprise network 115, the MNO-1 network 120, or the MNO-2 network 125 based on the comparison. The wireless-enabled devices 140-142 can then establish a connection with the enterprise network 115, the MNO-1 network 120, or the MNO-2 network 125 via the small cell 105 in response to providing the access request. As discussed herein, some embodiments of the wireless-enabled devices 140-142 are also able to establish connections with the MNO-1 network 120 or the MNO-2 network 125 via the corresponding macrocells 130, 135.

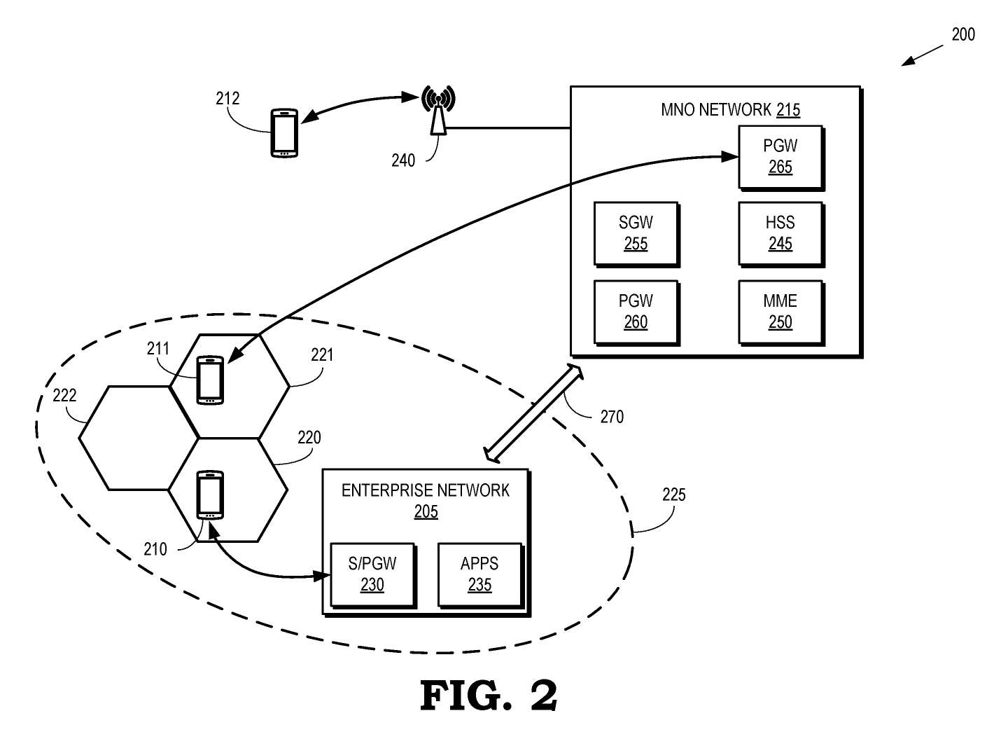

FIG. 2 is a block diagram of a wireless communication system 200 that includes an enterprise network 205 that is owned or operated by an enterprise according to some embodiments. The enterprise network 205 is used to implement some embodiments of the enterprise network 115 shown in FIG. 1. The wireless communication system 200 provides wireless connectivity to wireless-enabled devices 210, 211, 212 (collectively referred to herein as “the wireless-enabled devices 210-212”), which are used to implement some embodiments of the wireless-enabled devices 140-142 shown in FIG. 1. The wireless communication system 200 also includes an MNO network 215 that is used to implement some embodiments of the MNO-1 network 120 or the MNO-2 network 125 shown in FIG. 1.

The enterprise network 205 is connected to a set of small cells 220, 221, 222 (collectively referred to herein as “the small cells 220-222”), which provide wireless connectivity within a perimeter 225 that defines a boundary of the region associated with the enterprise. The illustrated embodiment of the enterprise network 205 includes a serving gateway and a packet data node (PDN) gateway (S/PGW) 230. The serving gateway portion of the S/PGW 230 routes and forwards user data packets. The serving gateway portion of the S/PGW 230 implements a control plane stacks to support an interface with a mobility management entity (MME), a control and data plane stacks to support an interface with the PGW portion of the S/PGW 230, and a data plane stacks to support an interface with the small cells 220-222. The PGW portion of the S/PGW 230 provides connectivity to external packet data networks and supports corresponding interfaces with the serving gateway portion, as well as other interfaces. The enterprise network 205 also supports a set of applications (APPS) 235 that are used to provide services to wireless-enabled devices that are authorized by the enterprise for private access to the enterprise network 205.

The MNO network 215 is connected to a macrocell 240 for providing wireless connectivity. The MNO network 215 includes a home subscriber server (HSS) 245 that is a central database that contains user and subscription related information to support mobility management, call and session establishment support, user authentication, and access authorization. The MNO network 215 also includes an MME 250 that supports paging, bearer activation/deactivation, authentication, and the like. The MME 250 terminates non-access stratum (NAS) signaling and ciphering/integrity protection. The MNO network 215 further includes a serving gateway (SGW) 255 and PGWs 260, 265. In the illustrated embodiment, the PGW 260 is dedicated to the enterprise and supports a connection 270 (such as a tunnel or a Virtual Private Network, VPN) between the MNO network 215 and the enterprise network 205. The PGW 265 is a gateway for subscribers to the MNO.

The wireless-enabled device 210 is a user equipment that is authorized by the enterprise network 205 and is also subscribed to the MNO that owns or operates the MNO network 215. For example, the enterprise network 205 can verify that the wireless-enabled device 210 is authorized using a verification process. The wireless-enabled device 210 is therefore able to access the enterprise network 205 via the small cell 220, e.g., by establishing a connection to the S/PGW 230, which provides connectivity to external networks. The wireless-enabled device 210 can use the connection to receive services provided by the applications 235 implemented in the enterprise network 205.

The wireless-enabled device 211 is a user equipment that is not authorized by the enterprise network 205 for private access. The wireless-enabled device 211 is subscribed to the MNO that owns or operates the MNO network 215. Since the small cells 220-222 are shared by the enterprise network 205 and the MNO network 215, the wireless-enabled device 211 is able to establish a connection with the MNO network 215 via the small cell 211. However, the wireless-enabled device 211 is not an authorized enterprise device and is therefore not able to access the enterprise network 205. The wireless-enabled device 211 therefore forms a connection over an air interface to the small cell 221, which routes information associated with the wireless-enabled device 211 to the SGW 255 and the PGW 265 in the MNO network 215.

The wireless-enabled device 212 is a user equipment that is authorized by the enterprise network 205 and is also subscribed to the MNO that owns or operates the MNO network 215. In the illustrated embodiment, the wireless-enabled device 212 is outside the coverage areas of the small cells 220-222. The wireless-enabled device 212 therefore establishes a connection with the enterprise network 205 via the macrocell 240 and the MNO network 215. For example, the wireless-enabled device 212 can request a PDN connection to the enterprise network 205. The PDN connection between the wireless-enabled device 212 and the enterprise network 205 traverses a communication pathway that includes the macrocell 240, the SGW 255, the PGW 260, and the connection 270. The wireless-enabled device 212 is therefore able to receive services provided by the applications 235 implemented in the enterprise network 205.

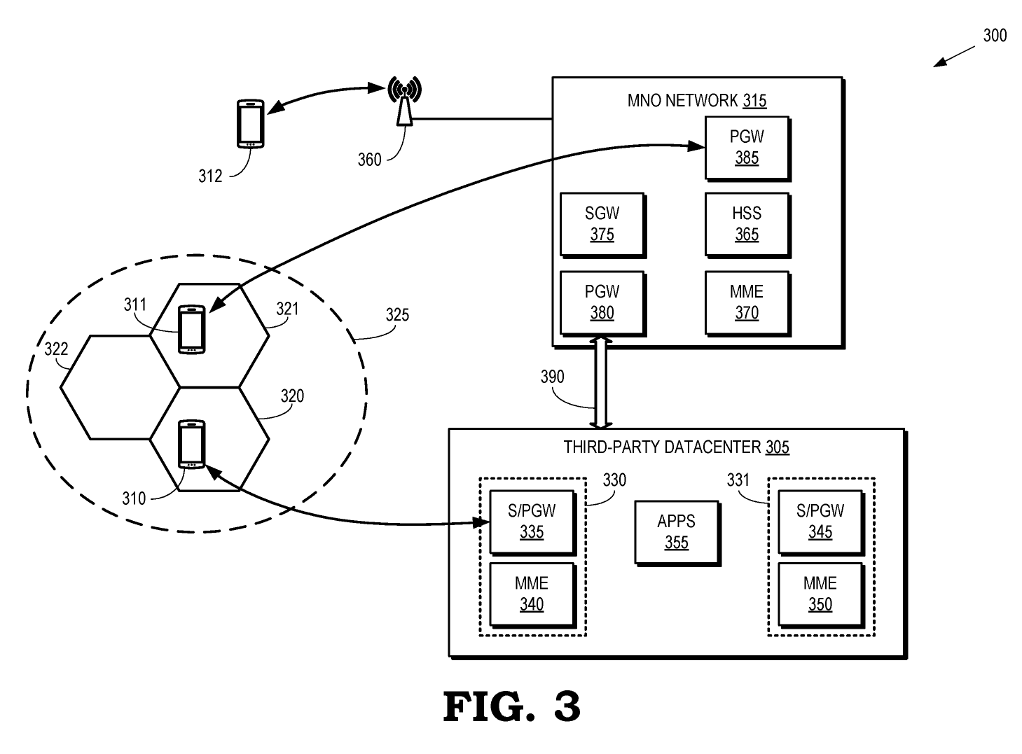

FIG. 3 is a block diagram of a wireless communication system 300 that includes a third-party datacenter 305 that is supports an enterprise network for an enterprise according to some embodiments. The third-party datacenter 305 is used to implement some embodiments of the enterprise network 115 shown in FIG. 1. The wireless communication system 300 provides wireless connectivity to wireless-enabled devices 310, 311, 312 (collectively referred to herein as “the wireless-enabled devices 310-312”), which are used to implement some embodiments of the wireless-enabled devices 140-142 shown in FIG. 1. The wireless communication system 300 also includes an MNO network 315 that is used to implement some embodiments of the MNO-1 network 120 or the MNO-2 network 125 shown in FIG. 1.

The third-party datacenter 305 is connected to a set of small cells 320, 321, 322 (collectively referred to herein as “the small cells 320-322”), which provide wireless connectivity within a perimeter 325 that defines a boundary of the region associated with the enterprise. The illustrated embodiment of the third-party datacenter 305 implements MNO-specific modules 330, 331 that are used to support enterprise connectivity. For example, the MNO-specific module 330 can be supported by the MNO that implements the MNO network 315 and the MNO-specific module 331 can be supported by another MNO that supports another MNO network (not shown in FIG. 3). The MNO-specific module 330 implements a S/PGW 335 and an MME 340. For example, the S/PGW 335 and the MME 340 can be implemented as virtual functions by the third-party datacenter 305. The MNO-specific module 331 implements a S/PGW 345 and an MME 350. For example, the S/PGW 345 and the MME 350 can be implemented as virtual functions by the third-party datacenter 305. The third-party datacenter 305 also implements a set of applications 355 that are used to provide services to wireless-enabled devices that are associated with the enterprise.

The MNO network 315 is connected to a macrocell 360 for providing wireless connectivity. The MNO network 315 includes an HSS 365, an MME 370, an SGW 375, and PGWs 380, 385. In the illustrated embodiment, the PGW 380 is dedicated to the enterprise and supports a connection 390 (such as a tunnel or a VPN) between the MNO network 315 and the enterprise network 305. The PGW 385 is a gateway for subscribers to the MNO.

The wireless-enabled device 310 is a user equipment that is authorized for private access to the enterprise network that is supported by the third-party datacenter 305. The wireless-enabled device 310 is also subscribed to the MNO that owns or operates the MNO network 315. The wireless-enabled device 310 is therefore able to access the enterprise network supported by the third-party datacenter 305 via the small cell 320, e.g., by establishing a connection to the S/PGW 330 and the MME 340 in the corresponding MNO-specific module 330. The wireless-enabled device 310 can use the connection to receive services provided by the applications 355 implemented in the third-party datacenter 305 on behalf of the enterprise.

The wireless-enabled device 311 is a user equipment that is not authorized for private access to the enterprise network. The wireless-enabled device 311 is subscribed to the MNO that owns or operates the MNO network 315. Since the small cells 320-322 are shared by the enterprise network implemented in the third-party datacenter 305 and the MNO network 315, the wireless-enabled device 311 is able to establish a connection with the MNO network 315 via the small cell 311. However, the wireless-enabled device 311 is not an enterprise device and is therefore not able to access the enterprise network implemented in the third-party datacenter 305. The wireless-enabled device 311 therefore forms a connection over an air interface to the small cell 321, which routes information associated with the wireless-enabled device 311 to the SGW 375 and the PGW 385 in the MNO network 315.

The wireless-enabled device 312 is a user equipment that is authorized for private access to the enterprise network implemented in the third-party datacenter 305. The wireless-enabled device 312 is also subscribed to the MNO that owns or operates the MNO network 315. In the illustrated embodiment, the wireless-enabled device 312 is outside the coverage areas of the small cells 320-322. The wireless-enabled device 312 therefore establishes a connection with the enterprise network via the macrocell 360 and the MNO network 315. For example, the wireless-enabled device 312 can request a PDN connection to the enterprise network implemented in the third-party datacenter 305. The PDN connection between the wireless-enabled device 312 and the third-party datacenter 305 traverses a communication pathway that includes the macrocell 360, the SGW 375, the PGW 380, and the connection 390. The wireless-enabled device 312 is therefore able to receive services provided by the applications 355 implemented in the third-party datacenter 305 on behalf of the enterprise.

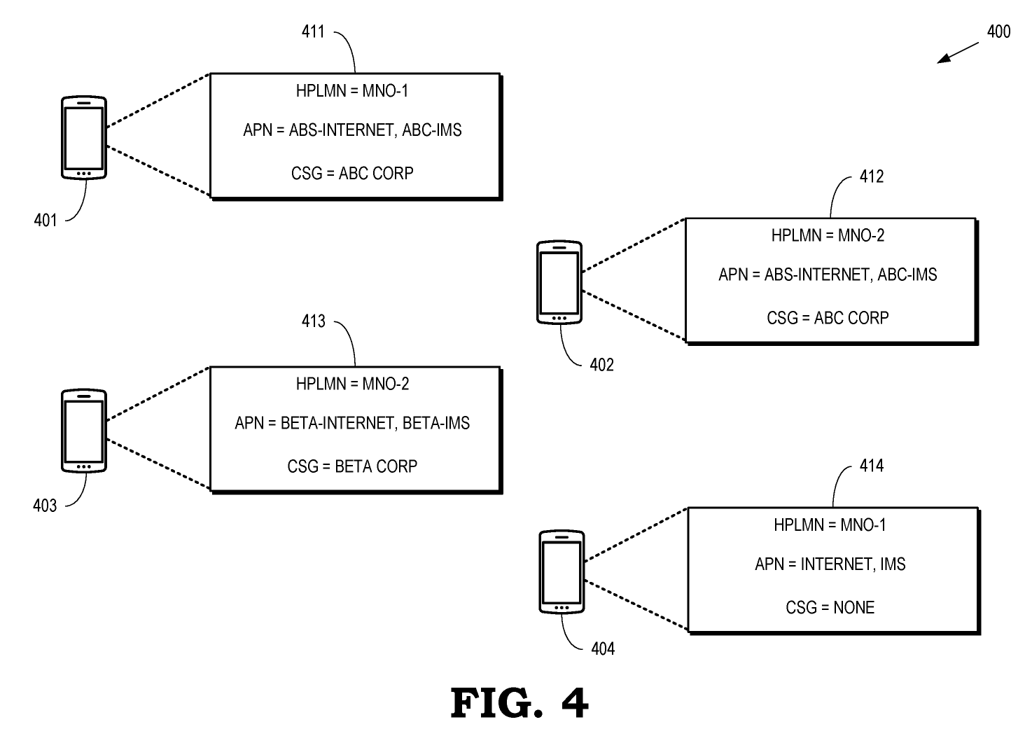

FIG. 4 illustrates a set 400 of wireless-enabled devices that are configured to access enterprise networks and public networks according to some embodiments. The set 400 includes the wireless-enabled devices 401, 402, 403, 404, which are collectively referred to herein as “the wireless-enabled devices 401-404.” The wireless-enabled devices 401-404 are used to implement some embodiments of the wireless-enabled devices 140-142 shown in FIG. 1. The wireless-enabled devices 401-404 are configured using corresponding configuration information 411, 412, 413, 414, which is collectively referred to herein as “the configuration information 411-414.”

The configuration information 411-414 includes information indicating the home PLMN of the MNO to which the corresponding wireless-enabled devices 401-404 are subscribed. For example, the configuration information 411 indicates that the wireless-enabled device 401 is subscribed to MON-1, the configuration information 412 indicates that the wireless-enabled device 402 is subscribed to MON-2, the configuration information 413 indicates that the wireless-enabled device 403 is subscribed to MON-2, and the configuration information 414 indicates that the wireless-enabled device 404 is subscribed to MNO-1. The configuration information 411-414 also includes information indicating whether the wireless-enabled devices 401-404 are authorized for private access to an enterprise network. For example, the configuration information 411 indicates that the wireless-enabled device 401 is authorized by the enterprise ABS, the configuration information 412 indicates that the wireless-enabled device 402 is authorized by the enterprise ABS, and the configuration information 413 indicates that the wireless-enabled device 403 is authorized by the enterprise BETA. The configuration 414 indicates that the wireless-enabled device 404 is not authorized for private access by an enterprise and therefore uses public access to the Internet or Internet multimedia subsystem (IMS) network.

Some embodiments of the wireless-enabled devices 401-404 are members of a closed subscribed group (CSG) for the corresponding enterprises. A CSG is a set of users (e.g., the wireless-enabled devices 401-404) that are able to access a small cell at the highest priority and receive all of the services provided by the small cell. Users in the CSG can be indicated by an access control list implemented in the small cell. Small cells can be configured as “closed” cells that only provide access to users in the CSG and do not provide any access to users that are not in the CSG. Small cells can also be configured as “hybrid” cells that provide high priority access and full services to users in the CSG. Users that are not in the CSG can still receive access, but at lower priority, and the users that are not in the CSG may not receive all of the services provided by the small cell.

The configuration information 411-414 can indicate membership in one or more CSG. For example, the configuration information 411 indicates that the wireless-enabled device 401 is a member of the CSG that is limited to users that are associated with ABC Corporation, the configuration information 412 indicates that the wireless-enabled device 402 is a member of the CSG that is limited to users that are associated with ABC Corporation, and the configuration information 413 indicates that the wireless-enabled device 403 is a member of the CSG that is limited to users that are associated with BETA Corporation. The configuration information 414 indicates that the wireless-enabled device 404 is not associated with a CSG.

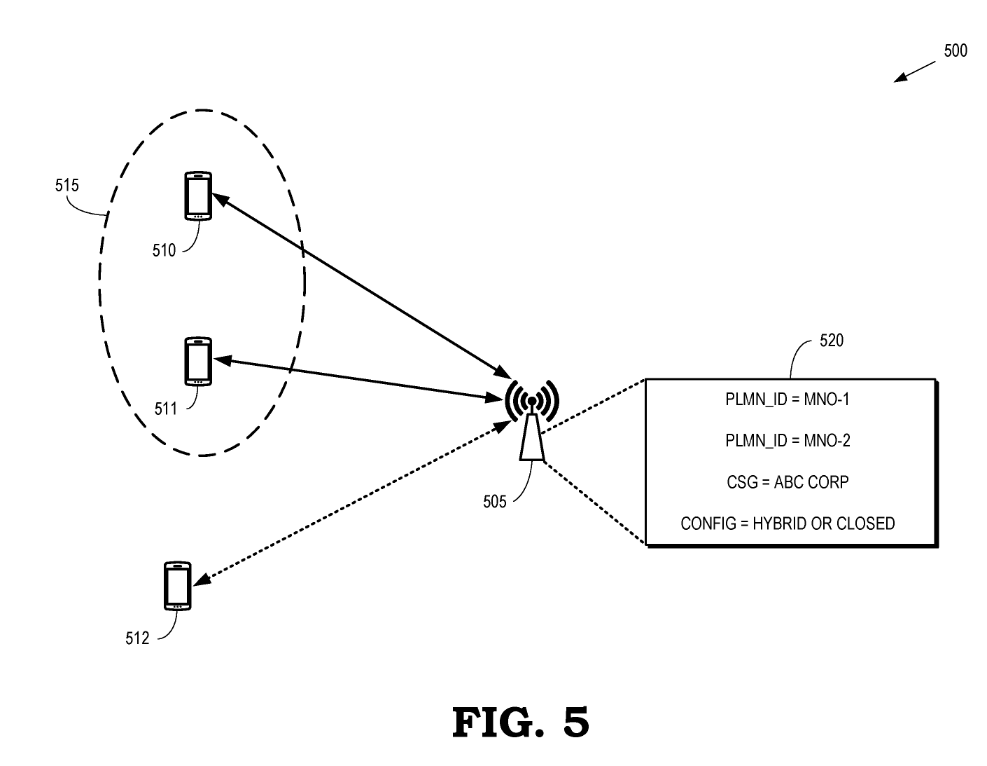

FIG. 5 illustrates a wireless communication system 500 including a small cell 505 that is configured to selectively provide access to wireless-enabled devices in closed subscriber groups (CSGs) according to some embodiments. The small cell 505 is used to implement some embodiments of the small cell 105 shown in FIG. 1. The wireless-enabled devices 510, 511, 512 (collectively referred to herein as “the wireless-enabled devices 510-512”) are used to implement some embodiments of the wireless-enabled devices 140-142 shown in FIG. 1. In the illustrated embodiment, the wireless-enabled devices 510, 511 are members of a CSG 515 for the small cell 505 and the wireless-enabled device 512 is not a member of the CSG 515.

The small cell 505 is owned or operated by an enterprise (ABC Corporation) and is configured using configuration information 520. In the illustrated embodiment, the configuration information 520 includes information identifying the networks that share access to the small cell 505 with the enterprise network. For example, the configuration information 520 includes PLMN identifiers that identify MNO-1 and MNO-2 as networks that share access to the small cell 505. The configuration information 520 also indicates CSG for the small cell 505. For example, the configuration information 520 indicates that the CSG 515 is limited to users that are associated with the ABC Corporation. The configuration information 520 also includes information that configures the small cell 505 as a hybrid or closed cell for the corresponding CSG 515. The small cell 505 can broadcast information identifying the enterprise network, MNO-1, and MNO-2. Some embodiments of the small cell 505 can also broadcast information identifying the CSG 515.

Access to the enterprise network, the MON-1, or the MNO-2 is selectively provided to the wireless-enabled devices 510-512 based on information included in access requests received at the small cell 505 and subscription data authorizing the requested access such as that recorded in HSS 365 shown in FIG. 3. For example, if the wireless-enabled device 510 is an authorized enterprise device that is subscribed to MNO-1 and is a member of CSG 515, the small cell 505 provides private access to the enterprise network at the highest priority and with access to all of the services provided by the small cell 505, as indicated by the solid, double-headed arrow line. For another example, if the wireless-enabled device 512 is not an authorized enterprise device and is not a member of the CSG 515, but it is subscribed to MON-2, the small cell 505 can provide public access to a core network supported by the MNO-2 if the small cell 505 is configured for hybrid CSG. The public access can be provided at a lower priority or with reduced (or no) access to the services provided by the small cell 505, as indicated by the dashed, double-headed arrow line. Some embodiments of the small cell 505 can deny access to the wireless-enabled device 512 if the small cell is configured for closed CSG.

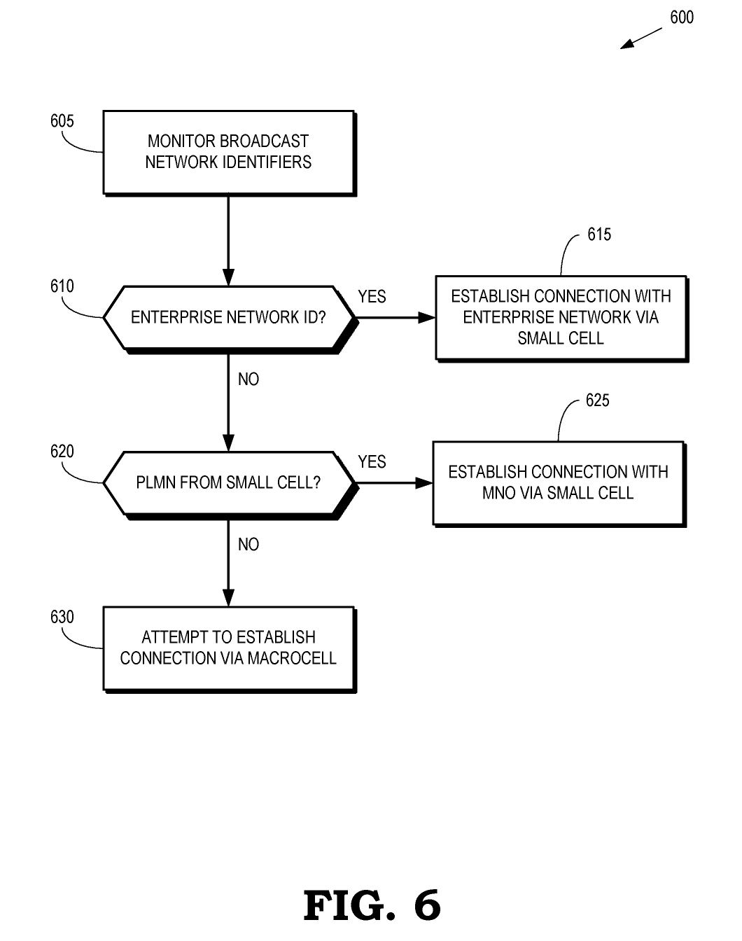

FIG. 6 is a flow diagram of a method 600 implemented in a wireless-enabled device for establishing a connection to an enterprise network or an MNO via a small cell according to some embodiments. The method 600 is implemented in some embodiments of the wireless communication system 100 shown in FIG. 1, the wireless communication system 200 shown in FIG. 2, and the wireless communication system 300 shown in FIG. 3.

At block 605, the wireless-enabled device monitors broadcast signals including network identifiers. The broadcast signals are broadcast by a small cell that provides shared access to an enterprise network and one or more MNO core networks. As discussed herein, the broadcast signals can include information identifying the enterprise network, the one or MNO core networks, a CSG associated with the small cell, and the like.

At decision block 610, the wireless-enabled device compares the information in the broadcast signals to configuration information stored in the wireless-enabled device. For example, the wireless-enabled device can compare a stored APN that indicates an enterprise network that is authorized the wireless-enabled device to information identifying an enterprise network associated with the small cell. If the information matches, indicating that the wireless-enabled device is authorized for private access to the enterprise network, the method 600 flows to block 615,where the wireless-enabled device attempts to establish a connection with the enterprise network via the small cell, e.g., by transmitting an access request to the small cell that includes information identifying the enterprise network and the requested access is verified against subscription data. If the information does not match, indicating that the wireless-enabled device is not authorized for private access to the enterprise network, the method 600 flows to decision block 620.

At decision block 620, the wireless-enabled device compares the information in the broadcast signals to be stored configuration information to determine whether the wireless-enabled device is subscribed to one of the MNOs that share access to the small cell. For example, the wireless-enabled device can compare a stored PLMN that identifies an MNO subscription to broadcast information indicating the PLMNs of the MNOs that share access to the small cell. If the stored PLMN matches one of the broadcast PLMNs, the method 600 flows to block 625 and the wireless-enabled device attempts to establish a connection with a core network supported by the corresponding MNO via the small cell. If the stored PLMN does not match any of the broadcast PLMNs, the method 600 flows to block 630 and the wireless-enabled device attempts to establish a connection with a core network of the MNO indicated by the MNO subscription via a macrocell that is connected to the core network.

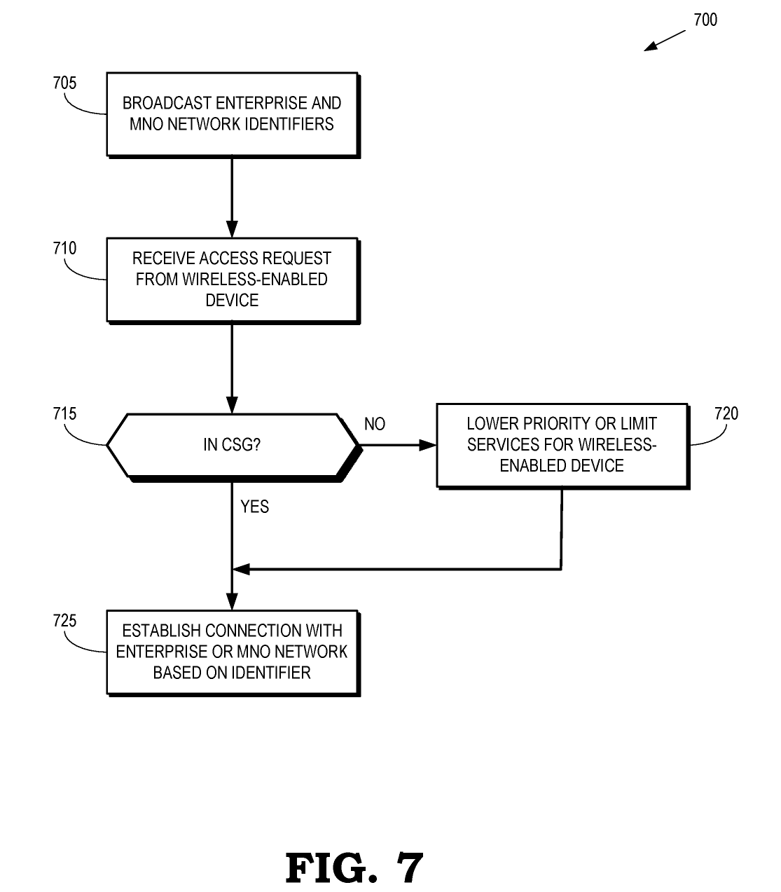

FIG. 7 is a flow diagram of a method 700 for selectively providing access to an enterprise network or an MNO network via a small cell according to some embodiments. The method 700 is implemented in some embodiments of the wireless communication system 100 shown in FIG. 1, the wireless communication system 200 shown in FIG. 2, and the wireless communication system 300 shown in FIG. 3.

At block 705, the small cell broadcasts information identifying an enterprise network and one or more MNO networks that share access via the small cell. For example, the small cell can broadcast an APN that identifies the enterprise network and one or more PLMNs that identify one or more MNOs that own or operate the one or more MNO networks.

At block 710, the small cell receives an access request from a wireless-enabled device. The access request can include information identifying the enterprise network to indicate, when checked against subscription data, that the user equipment is authorized for private access to the enterprise network via the small cell. The access request can also include information identifying a subscription to an MNO to indicate that the wireless-enabled device is subscribed to receive access from the MNO.

At decision block 715, the small cell determines whether the wireless-enabled device is a member of a CSG for the small cell. If not, the method 700 flows to block 720 and the small cell lowers a priority for access and/or limits services that are provided to the wireless-enabled device. The method 700 then flows to block 725. If the wireless-enabled device is a member of the CSG, the method 700 flows directly to the block 725. Some embodiments of the small cell do not implement CSG, in which case the decision block 715 and the block 720 are omitted from the method 700.

At block 720, the small cell establishes a connection with the enterprise network or the MNO network based on the information included in the identifier and authorization based on the subscriber record. For example, the small cell can establish a connection between the wireless-enabled device and the enterprise network if the wireless-enabled device is associated with the enterprise network. For another example, the small cell can establish a connection between the wireless-enabled device and the MNO network if the wireless-enabled device is not associated with the enterprise network, but the wireless-enabled device does have a subscription with the MNO that implements the MNO network.

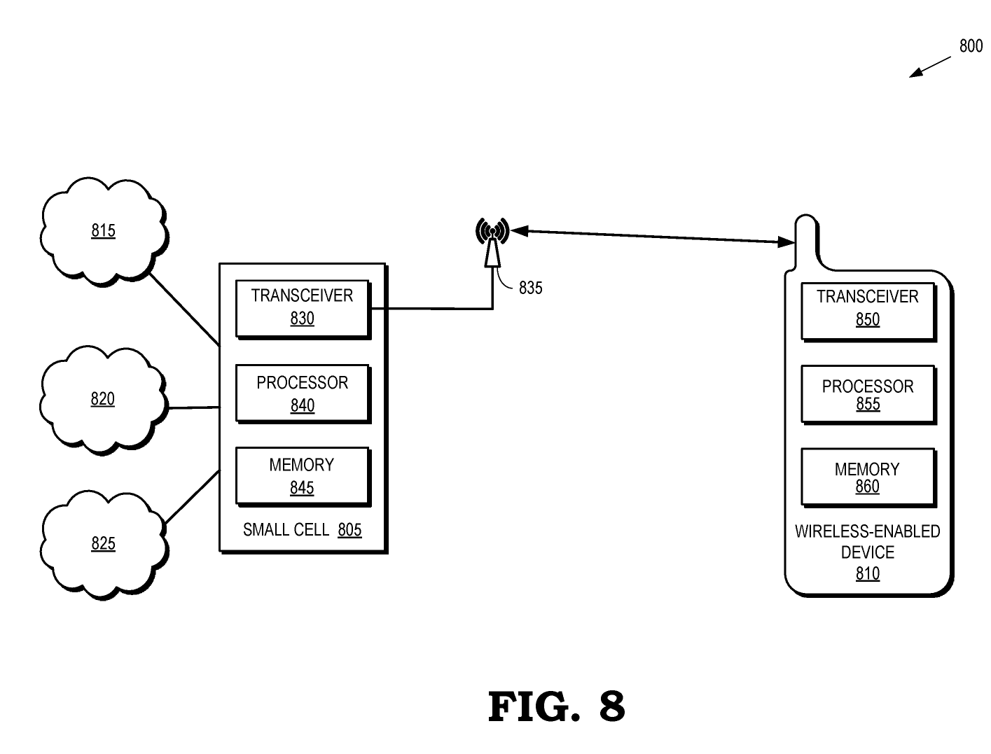

FIG. 8 is a block diagram of a wireless communication system 800 that includes a small cell 805 to provide shared access to an enterprise network and one or more MNO networks according to some embodiments. The wireless communication system 800 is used to implement some embodiments of the wireless communication system 100 shown in FIG. 1, the wireless communication system 200 shown in FIG. 2, and the wireless communication system 300 shown in FIG. 3. The small cell 805 is configured to provide wireless connectivity to a wireless-enabled device 810 and to provide shared access to an enterprise network 815, a first MNO network 820, a second MNO network 825, and potentially one or more additional networks.

The small cell 805 includes a transceiver 830 for transmitting and receiving signals using one or more antennas 835. For example, the transceiver 830 can be configured to operate according to one or more wireless communication standards to support wireless communication over an air interface using the antenna 835. Although the small cell 805 is depicted as a single physical entity in FIG. 8, some embodiments of the small cell 805 are implemented in parts or in a distributed manner. For example, remote radio heads and portions of the radio protocol base band processing can be co-located with the antenna 835, co-located with other small cells, virtually instantiated in a data center, and the like. Thus, the functionality of the small cell 805 can be distributed so that portions of the functionality are implemented at an antenna site and other portions of the functionality are implemented in a data center that implements a virtual radio access network (RAN). The transceiver 830 is also configured to communicate with the networks 815, 820, 825. Thus, the transceiver 830 can selectively provide the wireless-enabled device 810 with access to one or more of the networks 815, 820, 825. The transceiver 830 can be implemented as a single integrated circuit (e.g., using a single ASIC or FPGA) or as a system-on-a-chip (SOC) that includes different modules for implementing the functionality of the transceiver 830.

The small cell 805 also includes a processor 840 and a memory 845. The processor 840 may be used to execute instructions stored in the memory 845 and to store information in the memory 845 such as the results of the executed instructions. Some embodiments of the processor 840 are configured to selectively provide the wireless-enabled device 810 with private access to an enterprise network or public access to an MNO core network based on an identifier included in an access request received from the wireless-enabled device 810. For example, the processor 840 can be configured to perform some embodiments of the method 700 shown in FIG. 7.

The wireless-enabled device 810 includes a transceiver 850 transmitting and receiving signals. For example, the transceiver 850 can be configured to operate according to one or more wireless communication standards to support wireless communication over an air interface. The transceiver 850 can be implemented as a single integrated circuit (e.g., using a single ASIC or FPGA) or as a system-on-a-chip (SOC) that includes different modules for implementing the functionality of the transceiver 850. The wireless-enabled device 810 also includes a processor 855 and a memory 860. The processor 855 may be used to execute instructions stored in the memory 860 and to store information in the memory 860 such as the results of the executed instructions. Some embodiments of the processor 855 are configured to compare broadcast information received from the small cell 805 to configuration information stored in the memory 860. The processor 855 is also configured to selectively provide an access request to the small cell 805 including an identifier of one of the networks 815, 820, 825 based on the comparison. For example, the processor 855 can be configured to perform some embodiments of the method 600 shown in FIG. 6.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, at a small cell, an access request from a wireless-enabled device; and
selectively providing, via the small cell, the wireless-enabled device with private access to an enterprise network and public access to at least one core network of at least one mobile network operator based on an identifier included in the access request and verification by the enterprise network.

2. The method of claim 1, further comprising:
broadcasting, from the small cell, information identifying the enterprise network and the at least one core network of the at least one mobile network operator.

3. The method of claim 2, wherein broadcasting the information identifying the enterprise network and the at least one core network comprises broadcasting a network identifier of a third-party that provides the private access to the enterprise network and at least one public land mobile network (PLMN) identifier of the at least one mobile network operator.

4. The method of claim 3, wherein receiving the access request comprises receiving the network identifier of the third-party or the at least one PLMN identifier of the at least one mobile network operator.

5. The method of claim 4, wherein selectively providing the wireless-enabled device with private access or public access comprises providing the wireless-enabled device with private access to the enterprise network in response to receiving the network identifier of the third-party and providing the wireless-enabled device with public access to the at least one core network in response to receiving the at least one PLMN identifier of the at least one mobile network operator.

6. The method of claim 1, wherein the small cell is configured as a closed subscriber group (CSG) cell, and wherein selectively providing the wireless-enabled device with private access or public access comprises providing the wireless-enabled device with private access or public access in response to determining that the wireless-enabled device is a member of the CSG.

7. The method of claim 6, wherein selectively providing the wireless-enabled device with private access or public access comprises at least one of providing the wireless-enabled device with private access or public access at a lower priority, reducing services provided to the wireless-enabled device, or denying access to the wireless-enabled device in response to determining that the wireless-enabled device is not a member of the CSG.

8. A method, comprising:
receiving, at a wireless-enabled device from a small cell, broadcast information including identifiers of an enterprise network and at least one core network of at least one mobile network operator;
comparing, at the wireless-enabled device, the broadcast information to configuration information stored in the wireless-enabled device, wherein the configuration information includes identifiers of at least one of the enterprise network and the at least one core network; and
selectively providing, from the wireless-enabled device to the small cell, an access request including the identifier of the enterprise network or the at least one core network based on the comparison.

9. The method of claim 8, further comprising:
establishing a connection with at least one of the enterprise network or the at least one core network via the small cell in response to providing the access request and authorization verification by the enterprise network.

10. The method of claim 9, wherein selectively providing the access request comprises selectively providing an access request including the identifier of the enterprise network in response to the configuration information including the identifier of the enterprise network, and wherein establishing the connection comprises establishing the connection for private access to the enterprise network via the small cell.

11. The method of claim 9, wherein selectively providing the access request comprises selectively providing an access request including an identifier of one of the at least one core networks in response to the configuration information including the identifier of the one of the at least one core networks, and wherein establishing the connection comprises establishing the connection for public access to the one of the at least one core networks via the small cell.

12. The method of claim 9, wherein receiving the broadcast information comprises receiving at least one of a network identifier of a third-party that provides private access to the enterprise network or at least one PLMN identifier of the at least one mobile network operator.

13. The method of claim 12, wherein selectively providing the access request comprises selectively providing the network identifier of the third-party or the at least one PLMN identifier of the at least one mobile network operator based on the comparison.

14. The method of claim 9, wherein the small cell is configured as a closed subscriber group (CSG) cell, and wherein selectively providing the access request comprises providing information indicating whether the wireless-enabled device is a member of the CSG.

15. The method of claim 14, wherein establishing the connection comprises at least one of establishing the connection at a lower priority, receiving reduced services of the connection, or being denied access if the wireless-enabled device is not a member of the CSG.

16. A small cell comprising:
a transceiver configured to receive and access request from a wireless-enabled device; and
a processor configured to selectively provide the wireless-enabled device with private access to an enterprise network and public access to at least one core network of at least one mobile network operator based on an identifier included in the access request.

17. The small cell of claim 16, wherein functionality of at least one of the transceiver and the processor is distributed between an antenna site and a data center implementing a virtualized RAN.

18. The small cell of claim 17, wherein the transceiver is configured to broadcast information identifying the enterprise network and the at least one core network of the at least one mobile network operator.

19. The small cell of claim 18, wherein the transceiver is configured to broadcast a network identifier of a third-party that provides the private access to the enterprise network and at least one PLMN identifier of the at least one mobile network operator.

20. The small cell of claim 19, wherein the transceiver is configured to receive the network identifier of the third-party or the at least one PLMN identifier of the at least one mobile network operator.

21. The small cell of claim 20, wherein the processor is configured to provide the wireless-enabled device with private access to the enterprise network in response to the transceiver receiving the network identifier of the third-party and provide the wireless-enabled device with public access to the at least one core network in response to the transceiver receiving the at least one PLMN identifier of the at least one mobile network operator.

22. The small cell of claim 16, wherein the small cell is configured as a closed subscriber group (CSG) cell, and wherein the processor is configured to provide the wireless-enabled device with private access or public access in response to determining that the wireless-enabled device is a member of the CSG.

23. The small cell of claim 22, wherein the processor is configured to perform at least one of providing the wireless-enabled device with private access or public access at a lower priority, reducing services provided to the wireless-enabled device, or denying access to the wireless-enabled device in response to determining that the wireless-enabled device is not a member of the CSG.

24. A wireless-enabled device, comprising:
a transceiver configured to receive, from a small cell, broadcast information including identifiers of an enterprise network and at least one core network of at least one mobile network operator; and
a processor configured to compare the broadcast information to configuration information stored in the wireless-enabled device, wherein the configuration information includes identifiers of at least one of the enterprise network and the at least one core network, and wherein the processor is configured to selectively provide, to the small cell, an access request including the identifier of the enterprise network or the at least one core network based on the comparison.

25. The wireless-enabled device of claim 24, wherein the transceiver is configured to establish a connection with at least one of the enterprise network or the at least one core network via the small cell in response to providing the access request.

26. The wireless-enabled device of claim 25, wherein the processor is configured to selectively provide an access request including the identifier of the enterprise network in response to the configuration information including the identifier of the enterprise network, and wherein the transceiver is configured to establish the connection for private access to the enterprise network via the small cell.

27. The wireless-enabled device of claim 25, wherein the processor is configured to selectively provide an access request including an identifier of one of the at least one core networks in response to the configuration information including the identifier of the one of the at least one core networks, and wherein the transceiver is configured to establish the connection for public access to the one of the at least one core networks via the small cell.

28. The wireless-enabled device of claim 24, wherein the processor is configured to selectively provide at least one of a network identifier of a third-party that provides private access to the enterprise network or at least one PLMN identifier of the at least one mobile network operator.

29. The wireless-enabled device of claim 28, wherein the processor is configured to selectively provide the network identifier of the third-party or the at least one PLMN identifier of the at least one mobile network operator based on the comparison.

30. The wireless-enabled device of claim 24, wherein the small cell is configured as a closed subscriber group (CSG) cell, and wherein the processor is configured to provide information indicating whether the wireless-enabled device is a member of the CSG.

31. The wireless-enabled device of claim 30, wherein the transceiver is configured to perform at least one of establishing the connection at a lower priority, receiving reduced services the of the connection, or being denied access if the wireless-enabled device is not a member of the CSG.
